(19) United States
(12) Patent Application Publication
(10) Pub. No.: US 2024/0358002 A1
(43) Pub. Date: Oct. 31, 2024

(54) METHOD AND DEVICE FOR PROVIDING ANIMAL ENTITY STATUS INFORMATION BASED ON IMAGE

(71) Applicant: INTFLOW INC., Gwangju (KR)

(72) Inventor: Kwang Myung JEON, Gwangju (KR)

(21) Appl. No.: 18/671,522

(22) Filed: May 22, 2024

Related U.S. Application Data
(63) Continuation of application No. PCT/KR2024/005504, filed on Apr. 24, 2024.

(30) Foreign Application Priority Data
Apr. 28, 2023 (KR) 10-2023-0056350

(51) Int. Cl. A01K 29/00; A01K 11/00; G06T 5/80; G06T 7/60; G06T 7/80; G06V 10/764; G06V 40/10; H04N 7/18

(52) U.S. Cl. CPC A01K 29/005; A01K 11/006; G06T 5/80; G06T 7/60; G06T 7/80; G06V 10/764; G06V 40/10; H04N 7/18; G06T 2207/30242

(57) ABSTRACT

An animal entity status information providing device includes a memory configured to store an animal entity status information generation program, and a processor configured to execute the program, wherein the program performs calibration on a camera that sets a region of a straight passage through which an animal entity passes as an image-capturing region according to an initialization operation, sets a scale for an actual length per pixel by using image data received from the camera, counts a number of animal entities by identifying the animal entities in the image-capturing region for the image data to which the calibration is applied and, calculates sizes of the animal entities in the image-capturing region by using the scale, estimates weights of the animal entities based on the sizes of the animal entities, and outputs status information on the animal entities including the counted number and estimated weights.

### CROSS-REFERENCE TO RELATED APPLICATION

This application is a continuation of International Application No. PCT/KR2024/005504, filed on Apr. 24, 2024 in the Korean Intellectual Property Receiving Office, which is based on and claims priority to Korean Application No. 10-2023-0056350, filed on Apr. 28, 2023 in the Korean Intellectual Property Office, the entire disclosures of which are incorporated herein by reference.

### BACKGROUND

The present disclosure relates to an animal entity status information providing device and method that may count the number of animal entities moving in a straight passage, automatically recognize sizes of the animal entities, and estimate weights of the animal entities.

Recently, technology that provides various status information on animal entities based on images has been researched. For example, various technologies are being researched to manage animal entities more conveniently by identifying each animal entity within an image and tracking a movement status of the animal entity. The technology may be used in a barn where large quantities of livestock are raised, a space where various companion animals are managed, and so on.

The present disclosure provides a device that automatically counts the number of animal entities and automatically estimates weights of the animal entities in real time by using images captured by a camera.

In this case, in order to estimate a weight of an individual animal, a technology for accurately measuring a size of the animal entity is required. In relation to this, in the conventional art, information, such as a camera's angle of view, a lens length, and a focal length, has to be known previously to mathematically calculate a length of a captured image of a subject. Therefore, when information on a camera's specification is not known, it is difficult to mathematically calculate the length of the captured image of the subject.

Also, when capturing an image of a specific region by using a camera, there is a problem in that the captured image is distorted. In the end, the length of the subject may be accurately calculated only by solving the problem of lack of information on a camera (or image-capturing environment) and image distortion that may occur during an image-capturing process.

The present disclosure proposes a technology that solves the problem of the conventional art and may accurately calculate the status information of animal entities in an image.

### SUMMARY

The present disclosure provides an animal entity status information providing device and method that may solve image distortion occurring during image capturing by a camera and calculate status information, such as the number and weights of animal entities from an image.

Technical problems to be solved by the present embodiment is not limited to the technical problems described above, and other technical problems may exist.

According to a first aspect of the present disclosure, an animal entity status information providing device based on an image includes a memory configured to store an animal entity status information generation program, and a processor configured to execute the animal entity status information generation program, wherein as the animal entity status information generation program is executed by the processor, the animal entity status information generation program performs calibration on a camera that sets a region of a straight passage through which an animal entity passes as an image-capturing region according to an initialization operation, sets a scale for an actual length per pixel by using image data received from the camera, counts a number of animal entities by identifying the animal entities in the image-capturing region for the image data to which the calibration is applied and, calculates sizes of the animal entities in the image-capturing region by using the scale, estimates weights of the animal entities based on the sizes of the animal entities, and outputs status information on the animal entities including the counted number of animal entities and estimated weights of the animal entities.

According to a second aspect of the present disclosure, an information providing server that provides animal entity status information collected from at least one animal entity status information providing device includes a communication module, a memory configured to store an animal entity status information providing program, and a processor configured to execute the animal entity status information providing program, wherein as the animal entity status information providing program is executed by the processor, the animal entity status information providing program collects animal entity status information from at least one animal entity status information providing device, and provides the animal entity status information through a user interface of a user terminal in response to a request of an external user terminal, the animal entity status information includes a number of animal entities and an estimated weight of the animal entities collected by the animal entity status information providing device for a predetermined period of time, the number of animal entities is collected through an operation of counting the animal entities by identifying, by the animal entity status information providing device, the animal entities in an image-capturing region of a camera, and the estimated weight is collected through an operation of calculating, by the animal entity status information providing device, sizes of the animal entities by using a scale set through camera calibration, and estimating, by the animal entity status information providing device, weights of the animal entities based on the sizes of the animal entities.

According to a third aspect of the present disclosure, an animal entity status information generating method based on an image using an animal entity status information providing device includes calibrating a camera configured to set one region of a straight passage through which animal entities pass as an image-capturing region, setting a scale for an actual length per pixel by using image data received from the camera, counting the animal entities by identifying the animal entities in the image-capturing region from calibration-applied image data, calculating a size of one of the animal entities in the image-capturing region by using the scale, estimating weights of the animal entities based on the sizes of the animal entities, and outputting animal entity status information including the counted number of animal entities and estimated weights of the animal entities.

According to a fourth aspect of the present disclosure, a method of providing, by an information providing server, animal entity status information collected from an animal entity status information providing device to a user terminal includes collecting the animal entity status information from at least one animal entity status information providing device, and providing the animal entity status information through a user interface of a user terminal in response to a request from an external user terminal, wherein the animal entity status information includes a number of animal entities and an estimated weight of the animal entities collected by the animal entity status information providing device for a predetermined period of time, the number of animal entities is collected through an operation of counting the animal entities by identifying, by the animal entity status information providing device, the animal entities in an image-capturing region of a camera, and the estimated weight is collected through an operation of calculating, by the animal entity status information providing device, sizes of the animal entities by using a scale set through camera calibration, and estimating, by the animal entity status information providing device, weights of the animal entities based on the sizes of the animal entities.

### BRIEF DESCRIPTION OF THE DRAWINGS

Embodiments of the inventive concept will be more clearly understood from the following detailed description taken in conjunction with the accompanying drawings in which:

FIG. 1 illustrates a configuration of an animal entity status information providing system according to an embodiment of the present disclosure;

FIG. 2 illustrates a configuration of an animal entity status information providing device according to an embodiment of the present disclosure;

FIG. 3 illustrates an implementation example of an animal entity status information providing device according to an embodiment of the present disclosure;

FIG. 4 is a flowchart illustrating an operating method of an animal entity status information providing device, according to an embodiment of the present disclosure;

FIG. 5 is a diagram illustrating a calibration process of an animal entity status information providing device, according to an embodiment of the present disclosure;

FIG. 6 is a diagram illustrating a size of an animal entity according to an embodiment of the present disclosure;

FIG. 7 is a diagram illustrating a weight estimation process according to an embodiment of the present disclosure;

FIGS. 8A and 8B illustrates a user interface output from an animal entity status information providing device, according to an embodiment of the present disclosure;

FIG. 9 illustrates a detailed configuration of an information providing server according to an embodiment of the present disclosure;

FIGS. 10A to 10C illustrate pieces of animal entity status information displayed on a user terminal, according to an embodiment of the present disclosure;

FIG. 11 illustrates various statistical information providing interfaces displayed on a user terminal through an information providing server, according to an embodiment of the present disclosure; and

FIG. 12 is a flowchart illustrating a method of providing, by an information providing serve, animal entity status information to a user terminal, according to an embodiment of the present disclosure.

### DETAILED DESCRIPTION OF THE EMBODIMENTS

Hereinafter, embodiments of the present disclosure will be described in detail with reference to the accompanying drawings such that those skilled in the art in which the present disclosure belongs may easily practice the present disclosure. However, the present disclosure may be implemented in many different forms and is not limited to the embodiments described herein. In addition, in order to clearly describe the present disclosure, parts irrelevant to the description are omitted in the drawings, and similar reference numerals are attached to similar parts throughout the specification.

When it is described that a portion is “connected” to another portion throughout the specification, this includes not only a case where the portion is “directly connected” to another portion but also a case where the portion is “electrically connected” to another portion with another component therebetween. In addition, when it is described that a portion “includes” a certain component, this means that the portion may further include another component without excluding another component unless otherwise stated, and it should be understood that the presence or addition of one or more other features, numbers, steps, operations, elements, components, or combinations thereof are not precluded.

Following embodiments are detailed descriptions to aid understanding of the present disclosure and do not limit the scope of the present disclosure. Accordingly, inventions of the same scope and performing the same function as the present disclosure are also within the scope of claims of the present disclosure.

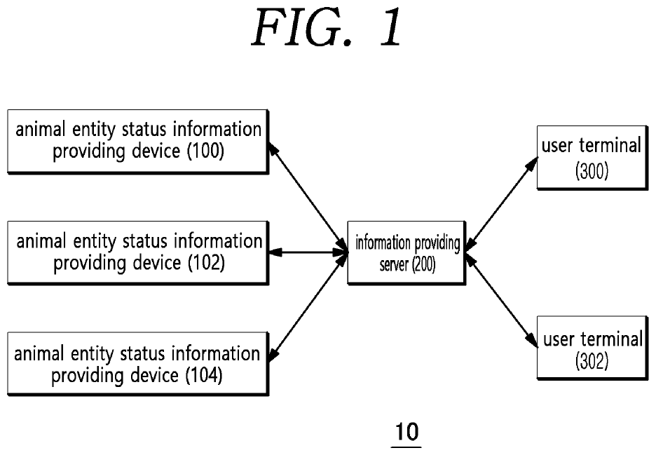

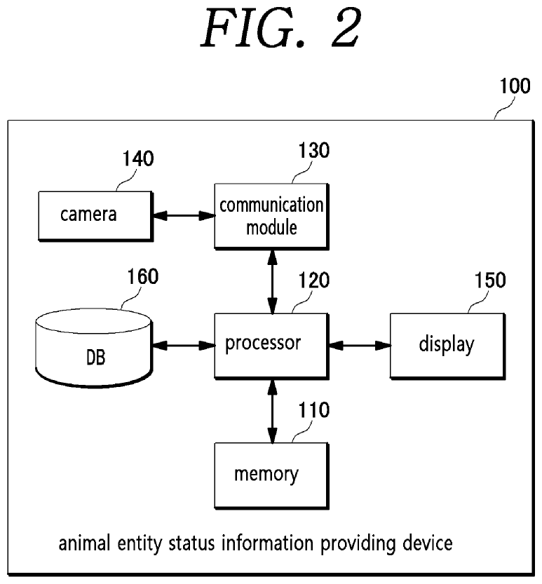

FIG. 1 illustrates a configuration of an animal entity status information providing system according to an embodiment of the present disclosure, and FIG. 2 illustrates a configuration of an animal entity status information providing device according to an embodiment of the present disclosure.

Referring to FIG. 1, an animal entity status information providing system 10 includes a plurality of animal entity status information providing devices 100, 102, and 104 arranged for each farm or livestock barn, an information providing server 200, and a plurality of user terminals 300 and 302. The animal entity status information providing devices 100, 102, and 104 directly identify animal entities from image data captured by a camera, count the number of animal entities, calculate sizes of the animal entities, and estimate weights of the animal entities. The animal entity status information providing devices 100, 102, and 104 are each disposed on a straight passage along which an animal entity moves, and the animal entity status information collected by the animal entity status information providing device 100 is transmitted to the information providing server 200 through data communication.

The information providing server 200 stores the animal entity status information together with the identification information of the animal entity status information providing device 100 in a database, which is managed at each measurement time. Also, the information providing server 200 provides animal entity status information to the user terminals 300 and 302 in response to a request from the user terminals 300 and 302. In this case, the information providing server 200 allows limited access only to the animal entity status information collected by the animal entity status information providing device 100 registered by matching each user account. Accordingly, each user may check the animal entity status information collected from the animal entity status information providing device 100 installed in a farm or livestock barn managed by each user in real time through the user terminal 300. Meanwhile, the information providing server 200 may operate in a cloud computing service model, such as software as a service (SaaS), platform as a service (PaaS), or infrastructure as a service (IaaS), or may be built in the form of a private cloud, public cloud, or hybrid cloud.

The user terminal 300 outputs animal entity status information collected by the animal entity status information providing device 100 installed at each location through a user interface (UI) through a dedicated application or web page. In this case, various types of animal entity status information displayed through the user terminal 300 will be described below in detail.

FIG. 2 is a block diagram illustrating a detailed configuration of an animal entity status information providing device according to an embodiment of the present disclosure.

As illustrated in FIG. 2, the animal entity status information providing device 100 includes a memory 110 and a processor 120. Also, the animal entity status information providing device 100 may further include a communication module 130, a camera 140, a display 150, and a database 160.

The memory 110 stores an animal entity status information generation program based on an image. As the animal entity status information generation program is executed by the processor 120, the animal entity status information generation program calibrates the camera 140 that sets a region of a straight passage, through which an animal entity passes, as an image-capturing region according to an initialization operation, sets a scale for an actual length per pixel by using image data received from the camera 140, identifies counts an animal entity by identifying the animal entity in a image-capturing region, calculates a size of the animal entity in the image-capturing region by using the scale, estimates a weight of the animal entity based on the size of the animal entity, and provides status information of the animal entity including the number of animal entities and the estimated weight of the animal entity.

Also, the memory 110 performs a function of temporarily or permanently storing the data processed by the processor 120. Here, the memory 110 may include volatile storage media or non-volatile storage media, but the scope of the present disclosure is not limited thereto.

The processor 120 executes the animal entity status information generation program stored in the memory 110. The processor 120 may refer to a data processing device which is built into hardware and has a physically structured circuit to perform function expressed by codes or instructions included in a program. The data processing device built into hardware may include, for example, a microprocessor, a central processing unit (CPU), a processor core, a multiprocessor, an application-specific integrated circuit (ASIC), a field programmable gate array (FPGA), and so on, but the scope of the present disclosure is not limited thereto.

The camera 140 is installed such that a region of a straight passage through which an animal entity passes is set as a field of view (FOV). The straight passage is a passage through which an animal entity moves, is formed to have a constant floor width and a predetermined length, and is a space provided a general animal breeding barn. A width of the straight passage is not limited in particular, but it is preferable to have a width in which one to two animals may move parallel to each other to more accurately capture the length or size of each animal. The camera 140 is fixed on an upper portion of the straight passage, and in particular, is located at a vertical upper portion of the straight passage such that distortion of an image of the camera 140 is reduced. Also, the animal entity status information providing device 100 may check information on a resource and installation position of the camera 140 in advance, and accordingly, the animal entity status information providing device 100 may correct image distortion caused by the camera 140 by using the information. In addition, the camera 140 may be connected to each of the animal entity status information providing devices 100, 102, and 104, but multiple cameras may be respectively connected thereto. In this case, when multiple cameras 140 are installed, the animal entity status information providing device 100 sets a separate image-capturing region for each of the multiple cameras 140, and processes counting and weight estimation tasks of animal entities for images captured by each of the multiple cameras 140 in parallel.

The communication module 130 transmits image data or control signals to the animal entity status information providing device 100 and the camera 140. Also, the communication module 130 may receive a data request from the camera 140 and transmit data as a response. Also, the communication module 130 performs data communication with the information providing server 200 or the user terminal 300. Here, the communication module 130 may be a device that includes hardware and software required to transmit and receive signals, such as control signals or data signals, through wired or wireless connections with other network devices.

The display 150 is provided on one side of the animal entity status information providing device 100 and outputs status information of an animal entity including the number of animal entities and estimated weights of the animal entities. The display 150 may be a general flat-type digital display having a built-in touch function. The user interface displayed through the display 150 will be described below in detail.

The database 160 may store characteristic information necessary for identification of animal entities, identification information of animal entities identified by a program, scale information calculated by the program, a size of each animal entity, and an estimated weight of each animal entity. Also, the database 160 may store lookup table information indicating the correlation between a size and a weight of an animal entity for each type of animal. The database 160 may be included as a separate component from the memory 110 or may be built in a partial region of the memory 110.

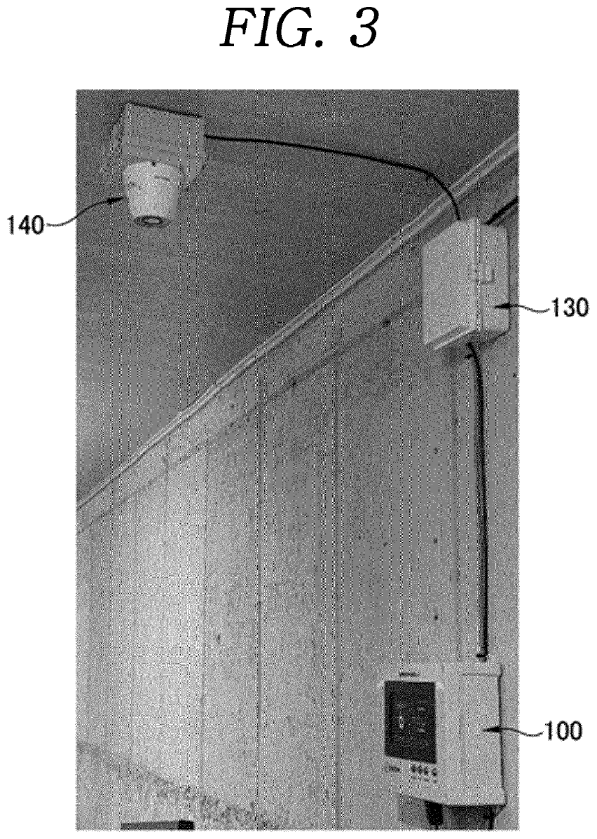

FIG. 3 illustrates an implementation example of an animal entity status information providing device according to an embodiment of the present disclosure.

As illustrated in FIG. 3, the communication module 130 may be placed outside a main body of the animal entity status information providing device 100. Also, the camera 140 may be placed to look at a image-capturing region on a lower side from a ceiling of a passage. The display 150 may be coupled to the outside of the main body.

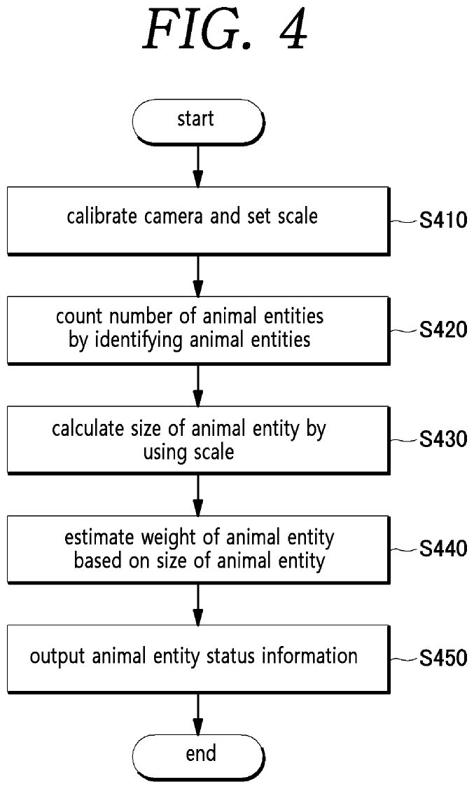

FIG. 4 is a flowchart illustrating an operating method of the animal entity status information providing device, according to an embodiment of the present disclosure.

First, when the animal entity status information providing device 100 is installed as illustrated in FIG. 3, the animal entity status information providing device 100 performs an operation of calibrating a camera and setting a scale in the initial stage (S410). To this end, a program may correct image distortion and set the scale based on an image obtained by capturing a checkerboard placed in one region of a straight passage.

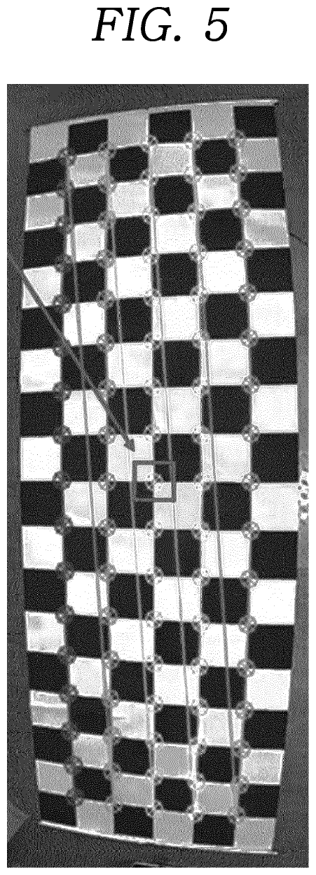

FIG. 5 is a diagram illustrating a calibration process of an animal entity status information providing device, according to an embodiment of the present disclosure.

As illustrated in FIG. 5, a checkerboard has a form in which a plurality of squares arranged in an array, and when the checkerboard is placed in a straight passage and an image is captured by the camera 140, it can be seen that a region immediately below the camera 140 is distorted in a relatively more enlarged form compared to a surrounding region. It may be seen that a plurality of vertices forming respective grids of the checkerboard, and a vertex in the center is set as a focus of the camera 140, and calibration is repeatedly performed on image frames to minimize the degree of distortion of the checkerboard. In this way, the calibration performed by using the checkerboard may be performed by using a polynomial distortion model which is also known as the Brown-Conrady model. That is, the calculation is performed multiple times to minimize distortion by adjusting distortion parameters of the polynomial distortion model and adjusting the degree of convexity or concavity to uniformize sizes of the squares in the checkerboard. For example, the calibration is performed repeatedly such that a mean square error (MSE) of a length of each line segment (marked in red) of each square in a top row of the checkerboard and a length of each line segment (marked in blue) of each square in a bottom row of the checkerboard is minimized. Once the calibration is completed, values of the distortion parameters constituting the polynomial distortion model are determined, and thereafter, image distortion is corrected by using the distortion parameters for newly captured images. The polynomial distortion model is known well, and for details, technical data of a link (<https://docs.nvidia.com/vpi/algo_ldc.html>) may be referred to.

In this way, a scale is set based on a distortion-corrected image. For example, by comparing a length of a unit line segment, which is defined as a length of one side of a square of the checkerboard with the number of pixels representing a unit line segment in distortion-corrected image data, a scale of an actual length to a pixel may be calculated. In this case, information on the length of the unit line segment of the checkerboard may be input by a user or may be stored in advance in the animal entity status information providing device 100. In this way, the calculated scale is used to calculate sizes of animal entities in the future. That is, when trying to calculate a length of a certain portion of an animal entity in a distortion-corrected image, the number of pixels representing the length is counted, a scale is applied to this, and an actual length of a certain portion is calculated by applying a scale thereto.

Next, referring back to FIG. 4, animal entities are identified in the distortion-corrected image, and the number of animal entities is counted (S420). When an animal entity appears in a captured region, an animal entity identification model included in an animal entity status information generation program automatically identifies the animal entity. For this purpose, the animal entity identification model is prepared in the form of a machine learning model that extracts characteristics of animal entities based on images and assigns identification numbers (IDs) to individual animal entities.

Also, the animal entity identification model may identify the type of animal. For example, in addition to domestic livestock, such as cows, pigs, chickens, and horses, companion animals, such as dogs and cats, may also be trained to be identified. Also, in the present disclosure, the camera 140 on an upper portion of an animal entity captures images, and accordingly, the back of the animal entity is mainly captured, and characteristics of the animal entity are extracted by using the captured image of the back.

Also, even within the same species, each animal entity may be identified based on visual characteristics (color, size, skeleton, and so on). To this end, an animal entity identification model may be built by using training data including images of several animals. In this case, a learning network to be used may include a convolutional neural network (CNN), a recurrent neural network (RNN), an auto encoder, a generative adversarial network (GAN), a deep belief network (DBN), and so on. In particular, the CNN may include one or more convolutional layers, a pooling layer, and fully connected layers.

In this way, animal entities may be identified by using images, identification information may be assigned to each individual entity, and thereby, the number of animal entities passing through a image-capturing region may be counted. In addition, counting and weight estimation of animal entities may be automatically performed from the time when the animal entity is identified at the image-capturing region to the time when the animal entity is not identified. Therethrough, counting and weight estimation of animal entities are automatically performed without separate setting of a manager. In this case, counting and weight estimation of animal entities may be performed cumulatively during a time section (for example, half a day, one day, and so on) set by a user. Accordingly, when counting and weight estimation of a group of animal entities are performed together, movements of the animal entities may be temporarily stopped and identification of the animal entities may be stopped, and when the animal entities are identified again, counting and weight estimation are automatically performed together, and thus, counting and weight estimation for all animal entities may be performed.

Next, a size of an animal entity may be calculated by using the previously calculated scale (S440). In this case, the size of the animal entity may represent a horizontal length, a vertical length, or a length of a certain part. In this case, the vertical length of the animal entity may refer to a length of the back of the animal entity or may be the entire length including both the head and the back. In addition, the number of pixels representing a length of a certain part of an animal entity in the distortion-corrected image is counted, and an actual length of the certain part may be calculated by applying a scale to the certain part.

Also, the size of the animal entity may refer to an area of a certain part of the animal entity. Also, the number of pixels representing an area of a certain part of an animal entity in the distortion-corrected image may be counted, and the area of the certain part may be calculated by applying a scale to the certain part.

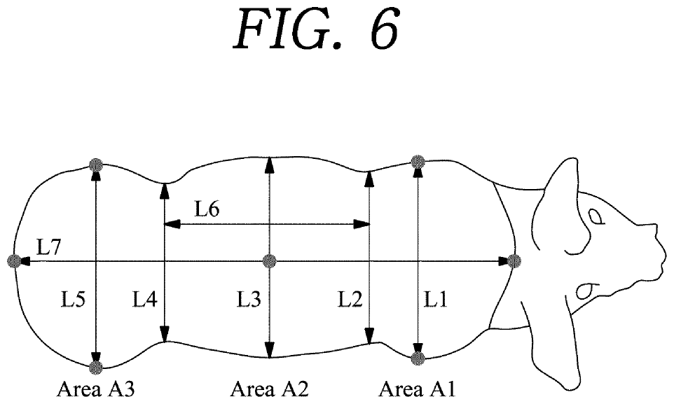

FIG. 6 is a diagram illustrating a size of an animal entity according to an embodiment of the present disclosure.

The animal entity status information providing device 100 may recognize multiple preset key points from a back image of an animal entity recognized from image data and calculate at least one back length by connecting the multiple key points to each other. In this case, the multiple key points may include at least one of both end points of the shoulder and both end points of the pelvis based on the neck, tail, and front legs of an animal entity.

For example, as illustrated in FIG. 6, seven preset key points marked on the back (torso) of a pig may be recognized. Also, the animal entity status information providing device 100 may optionally and additionally recognize and use a length and direction of the pig's head. Thereafter, the recognized key points may be connected to each other to calculate lengths of various portions L1 to L7.

Next, a weight of an animal entity is estimated based on the size of the animal entity (S450). The animal entity status information providing device 100 may estimate the weight of the animal entity by inputting the previously calculated size information of the animal entity to a lookup table representing a correlation between the size and weight of the animal entity.

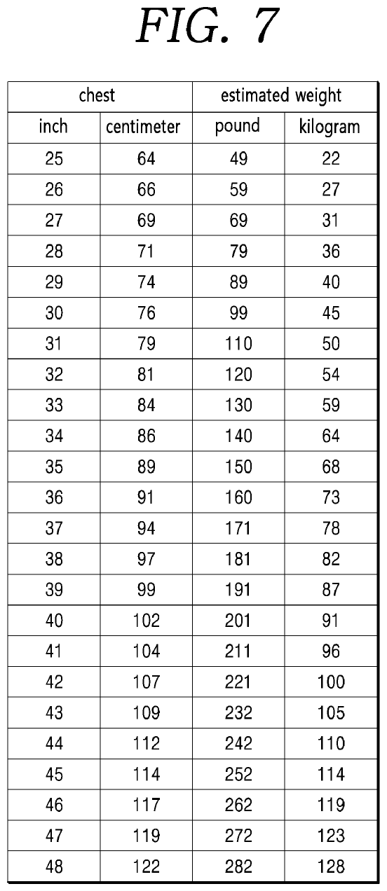

FIG. 7 is a diagram illustrating a weight estimation process according to an embodiment of the present disclosure.

When a horizontal or vertical length of a certain part of an animal entity is calculated, a corresponding weight may be output from the lookup table illustrated in FIG. 7. For example, as illustrated in FIG. 7, by using a look-up table illustrating a correlation between the chest and a weight of an animal entity, the weight of the animal entity may be estimated by using chest information of the animal entity calculated in step S440.

A plurality of lookup tables may be provided according to the type of animal entity. Also, a weight of an animal entity may be estimated by inputting the size information of the animal entity to a lookup table corresponding to the type of animal entity determined when identifying the animal entity.

Also, in the lookup table, information on the size of animal entity may also be set to one or multiple pieces. That is, a look-up table may be provided in a form in which the horizontal length, vertical length, and weight value of the animal entity match each other.

Next, status information of animal entity including the number of animal entities counted previously and the estimated weight of the animal entity is provided (S460).

In this way, the status information of animal entity may be output directly from the animal entity status information providing device 100 through the display 150, or output through the user terminal 300 and the information providing server 200.

In this case, the status information of the animal entity may include statistical values of the estimated weight of the counted animal entity. For example, an average or standard deviation of the estimated weights may be output.

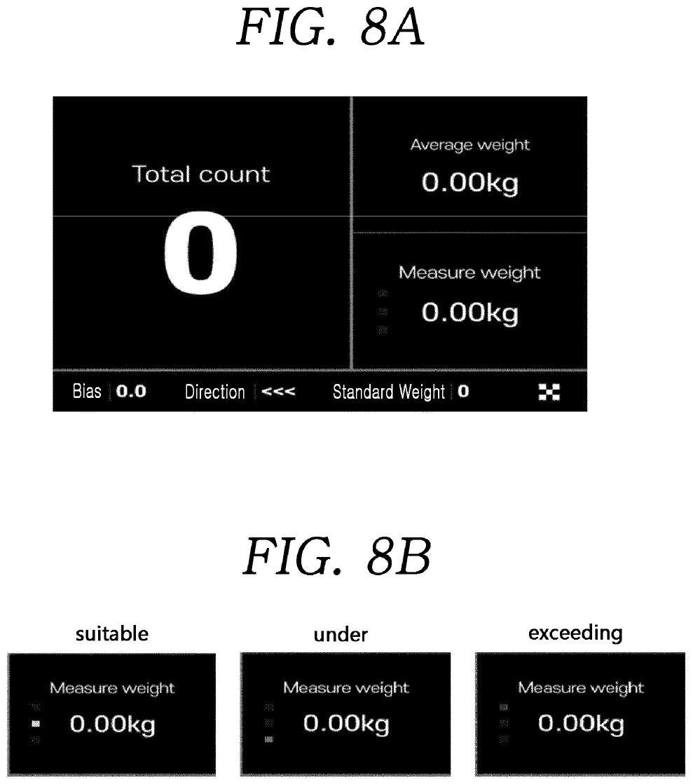

FIGS. 8A and 8B illustrates a user interface output from an animal entity status information providing device, according to an embodiment of the present disclosure.

As illustrated in FIG. 8A, the total count of animal entity and the estimated weight (measured weight) of each entity may be displayed. Also, an average weight of animal entities identified to date may be displayed.

Also, as illustrated in FIG. 8B, grades may be displayed as a result of comparing the estimated weight with a preset reference weight or a reference weight set by a user. For example, a suitable grade, an under grade, or an exceeding grade according to a difference between a reference weight and an estimated weight is output for each animal entity. For example, the suitable grade may be set to a case where a difference between the reference weight and the estimated estimate is within 5%, the under grade may be set to a case where the estimated weight is less than 95% of the reference weight, and the exceeding grade may be set to a case where the estimated weight exceeds 105% of the reference weight, but the cases may be changed depending on a user's settings.

As illustrated in FIG. 8B, indications of the suitable grade, the under grade, and the exceeding grade may be displayed more intuitively by using different colored lights (green, red, and blue) on one side of the weight.

In this way, status information of animal entities collected by the animal entity status information providing device 100 may be collected in the information providing server 200 and may be displayed through an app/web executed by the user terminal 300 according to a request of the user terminal 300.

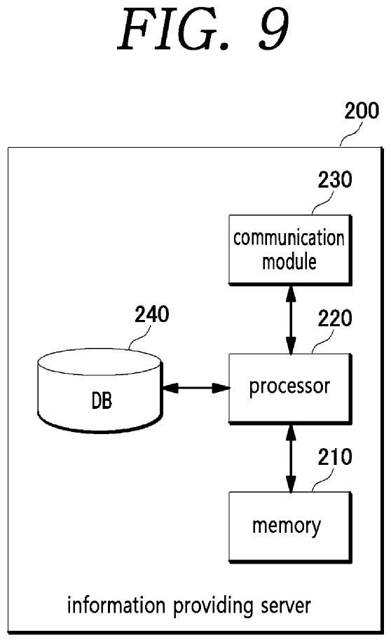

FIG. 9 illustrates a detailed configuration of the information providing server 200 according to an embodiment of the present disclosure.

The information providing server 200 may include a memory 210, a processor 220, a communication module 230, and a database 240.

The memory 210 stores an animal entity status information providing program. The animal entity status information providing program collects animal entity status information from the animal entity status information providing device 100 and provides various types of animal entity status information through a web or app-based user interface executed by the user terminal 300 according to a request of the user terminal 300. In this case, the animal entity status information includes the number of animal entities and the estimated weight of each animal entity collected by the animal entity status information providing device 100 for a predetermined period of time. In addition, the number of animal entities is obtained through an operation of identifying the animal entities in a camera's image-capturing region and counting the animal entities by using the animal entity status information providing device 100, the estimated weight is obtained through an operation of calculating sizes of the animal entities by using a scale set by the animal entity status information providing device 100 through camera calibration and estimating weights of the animal entities based on the sizes of the animal entities. Also, the memory 210 performs a function of temporarily or permanently storing the data processed by the processor 220. Here, the memory 210 may include volatile storage media or non-volatile storage media, but the scope of the present disclosure is not limited thereto.

The processor 120 executes an animal entity status information providing program stored in the memory 110. The processor 120 may refer to a data processing device which is built into hardware and has a physically structured circuit to perform function expressed by codes or instructions included in a program. The data processing device built into hardware may include, for example, a microprocessor, a CPU, a processor core, a multiprocessor, an ASIC, an FPGA, and so on, but the scope of the present disclosure is not limited thereto.

The communication module 230 transmits various types of data between the information providing server 200, the animal entity status information providing device 100, which is an external device, and the user terminal 300. In particular, the communication module 230 continuously collects animal entity status information from the animal entity status information providing device 100. Also, the communication module 230 provides the collected animal entity status information to the user terminal 300 in response to an information provision request from the user terminal 300. Here, the communication module 230 may be a device that includes hardware and software required to transmit and receive signals, such as control signals or data signals, through wired or wireless connections with other network devices.

The database 240 manages profile information of each user account, profile information of the animal entity status information providing device registered by each user account, and animal entity status information collected by each animal entity status information providing device. The profile information of the animal entity status information providing device may collect and manage various types of information, such as identification information of the animal entity status information providing device 100, information of a user who registers the animal entity status information providing device 100, information on a camera connected to the animal entity status information providing device 100, and maintenance-related Information of the animal entity status information providing device 100. The animal entity status information collected by animal entity status information providing device 100 may be collected and managed together with various types of information, such as device identification and collection date, number of animal entities, details of the estimated weight, and log information of a user. The database 240 may be included as a separate component from the memory 210 or may be built in a partial region of the memory 210.

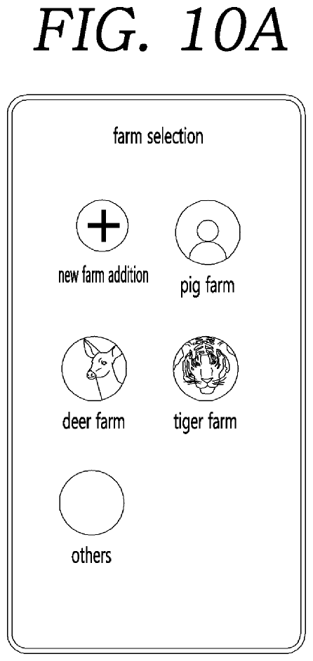

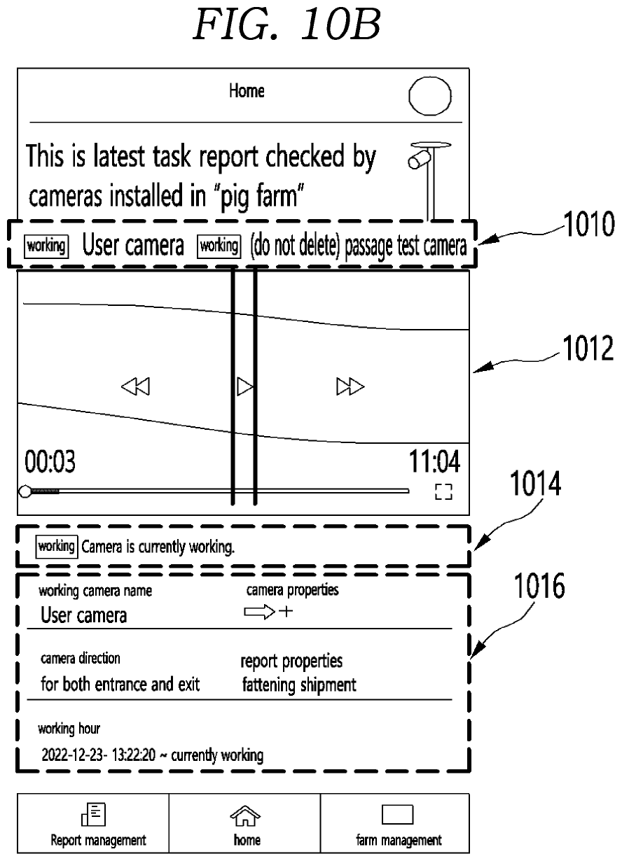

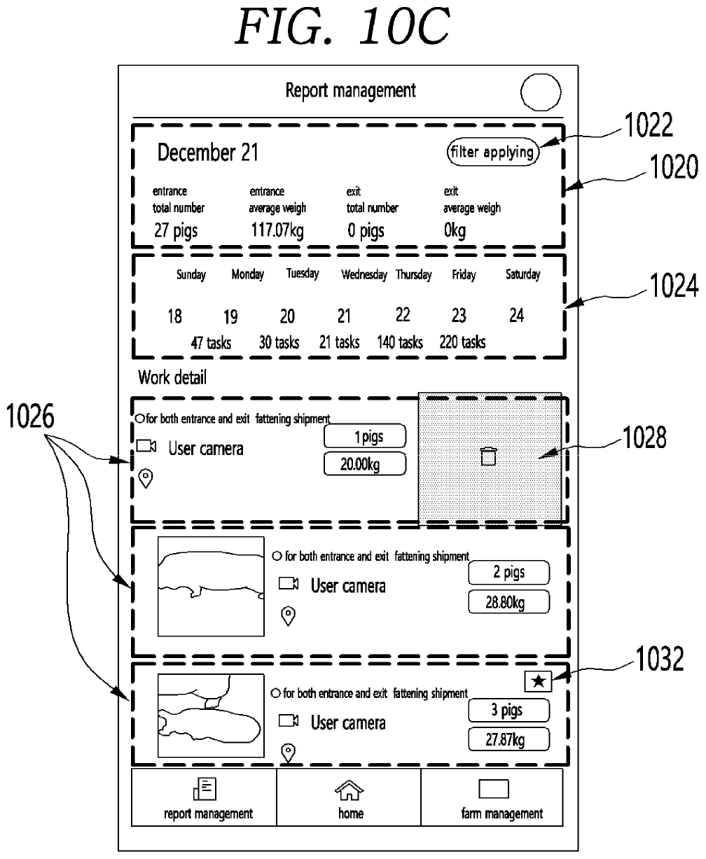

FIGS. 10A to 10C illustrate pieces of animal entity status information displayed through a user terminal, according to an embodiment of the present disclosure.

The information providing server 200 may provide information collected from one or more animal entity status information providing devices 100 registered for each user account to a user through a corresponding user terminal. As illustrated in FIG. 10A, a user terminal may provide information on multiple farms and allows a user to select one of the multiple farms or register a new farm. In this case, one or more animal entity status information providing devices 100 may be registered in each farm, and when a certain farm is selected, the animal entity status information collected by the animal entity status information providing device 100 installed on the farm may be checked.

When a certain farm is selected from an interface illustrated in FIG. 10A, the information providing server 200 may check an operation status of the animal entity status information providing device 100 installed on the farm through an interface shown in FIG. 10B. A first interface block 1010 may sequentially display information on multiple cameras installed in the farm, and a user may select one of the multiple cameras. By way of example, the first interface block 1010 may display information on multiple cameras by rotating pieces of information on the multiple cameras horizontally or vertically. When a user selects one camera through the first interface block 1010, an image captured by the camera is displayed through a second interface block 1012, and information on the operation status of the camera is displayed through a third interface block 1014. For example, the third interface block 1014 displays information on whether the camera is operating or waiting. A fourth interface block 1016 displays setting information of a selected camera. Information on a name assigned to the selected camera, a direction of movement of an animal entity in an image-capturing region, a work time, and so on may be displayed.

In addition, as illustrated in FIG. 10C, a report management interface displayed on the user terminal 300 through the information providing server 200 is provided. The information providing server 200 may display information, such as work date, the number of animal entities which is a main point of a report, and average weight, through a fifth interface block 1020. Also, a user may set filtering conditions to display only a desired report through a sixth interface block 1022 among multiple reports. For example, the user may set conditions, such as a sorting order according to time, an importance condition, and the type of camera. Also, as conditions related to the type of image-capturing region or a direction of movement of an animal entity, entrance (one-way passage for animals to enter from the outside), exit (one-way passage for animals to exit to the outside), both entrance/exit (a two-way passage that allows animals to enter or exit from or to the outside), internal movement (movement between livestock rooms in the farm), simple measurement (other movement), or so on may be selected.

Also, a weekly or monthly work status may be easily checked through a seventh interface block 1024. The seventh interface block 1024 is a calendar-based interface and may change a weekly or monthly interface through a user's swipe operation, and displays the number of tasks for each day. In this case, the number of tasks may refer to counting the number of animal entities and weight estimation performed by the animal entity status information providing device 100, and a report may be generated for each task. Also, when a certain date is selected through the seventh interface block 1024, a report for each task registered on a corresponding date may be displayed in an eighth interface block 1026 at the bottom.

Also, the eighth interface block 1026 displays reports for each task adjacent to the seventh interface block 1024 in the form of a list. In this case, the report for each task may be generated in time units determined by a user, such as hourly or weekly units or may be generated based on a time unit from the time when the animal entity begins to be identified to the time when the identification ends. The report for each task includes image data captured during a corresponding task, and information on the number and estimated weight of animal entities counted during the task. The reports for each task may be deleted according to a user's selection (1028). Also, a task in which the number of animal entities is counted above a threshold may be displayed together with a highlight 1032 indicating a level of importance.

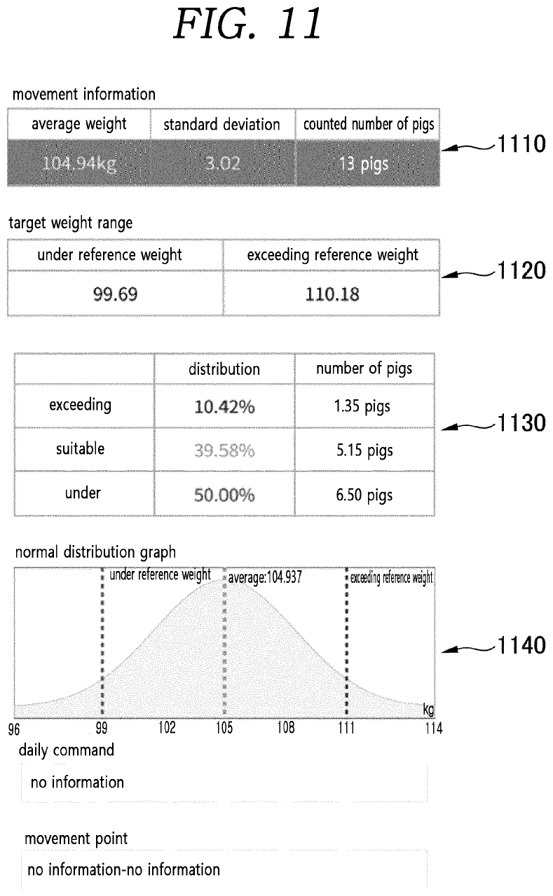

FIG. 11 illustrates various statistical information providing interfaces displayed on a user terminal through an information providing server, according to an embodiment of the present disclosure.

A user may set a desired collection group by segmenting the desired collection group into a farm unit, a camera unit, a time unit, a task unit, and so on, and the information providing server 200 or the user terminal 300 may display statistical information on tasks in the collection group selected by a user. For example, statistics on the number and average weight of entities based on measurements performed during a preset period at a preset farm selected by a user may be output through the first interface block 1110.

Also, based on the statistically calculated average weight, an under-reference weight and an over-reference weight may be output through the second interface block 1120. In this case, the under-reference weight and the over-standard weight may be set based on an average weight by considering a normal distribution. The third interface block 1130 may display the number and distribution status of animal entities corresponding to an under grade, a suitable grade, and an exceeding grade. The fourth interface block 1140 may display the number and distribution status of animal entities corresponding to the under grade, the suitable grade, and the exceeding grade through a normal distribution curve.

The reports or statistical information for each task may be generated through calculation operations performed by the information providing server 200 or the user terminal 300 based on the information collected by each the animal entity status information providing device 100.

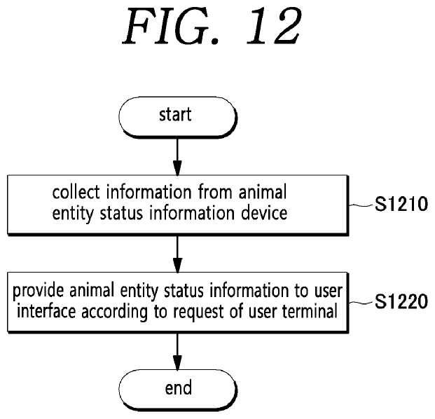

FIG. 12 is a flowchart illustrating a method of providing, by an information providing serve, animal entity status information to a user terminal, according to an embodiment of the present disclosure.

First, the information providing server 200 collects animal entity status information from at least one animal entity status information providing device 100 (S1210). The animal entity status information includes the number of animal entities and an estimated weight of each animal entity collected by the animal entity status information providing device 100 for a predetermined period of time. In particular, the number of animal entities is collected through an operation of the animal entity status information providing device 100 that identifies the animal entities in a camera's image-capturing region and counts the animal entities. Also, the estimated weight is collected through an operation of calculating sizes of the animal entities by using a scale set by the animal entity status information providing device 100 through camera calibration and estimating weights of the animal entities based on the sizes of the animal entities.

Next, the information providing server 200 provides animal entity status information through a user interface of an external user terminal in response to a request from the external user terminal (S1220). The animal entity status information may be provided in various forms through the user interface previously described with reference to FIGS. 10A to 11.

An animal entity status information providing device based on an image and an operating method thereof according to an embodiment of the present disclosure may solve image distortion that may occur due to image-capturing of a camera, more accurately calculate a length of livestock in an image, and estimate a weight of livestock based thereon.

Also, in this way, the collected animal entity status information is transmitted to an information providing server and provided to a user terminal, and accordingly, each user may check the animal entity status information collected in real time through the animal status information providing device installed on a farm or so on.

An embodiment of the present disclosure may be implemented in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

Although the method and system of the present disclosure are described with respect to specific embodiments, some or all of components or operations thereof may be implemented by using a computer system having a general-purpose hardware architecture.

The above descriptions of the present disclosure are for illustrative purposes only, and those skilled in the art to which the present disclosure belongs will understand that the present disclosure may be easily modified into another specific form without changing the technical idea or essential features of the present disclosure. Therefore, the embodiments described above should be understood as illustrative in all respects and not limiting. For example, each component described as a single type may be implemented in a distributed manner, and similarly, components described in a distributed manner may also be implemented in a combined form.

The scope of the present disclosure is indicated by the following claims rather than the detailed description above, and the meaning and scope of the claims and all changes or modifications derived from the equivalent concepts should be interpreted as being included in the scope of the present disclosure.

What is claimed is:

1. An animal entity status information providing device based on an image, the animal entity status information providing device comprising:
a memory configured to store an animal entity status information generation program; and
a processor configured to execute the animal entity status information generation program,
wherein as the animal entity status information generation program is executed by the processor, the animal entity status information generation program performs calibration on a camera that sets a region of a straight passage through which an animal entity passes as an image-capturing region according to an initialization operation, sets a scale for an actual length per pixel by using image data received from the camera, counts a number of animal entities by identifying the animal entities in the image-capturing region for the image data to which the calibration is applied and, calculates sizes of the animal entities in the image-capturing region by using the scale, estimates weights of the animal entities based on the sizes of the animal entities, and outputs status information on the animal entities including the counted number of animal entities and estimated weights of the animal entities.

2. The animal entity status information providing device of claim 1, further comprising:
a camera; and
a communication module configured to receive image data from the camera,
wherein the communication module transmits the counted number of animal entities and the estimated weights of the animal entities to one of a user terminal and an external computing device.

3. The animal entity status information providing device of claim 1, wherein
the program corrects image distortion based on an image obtained by capturing a checkerboard placed in the one region of the straight passage and set the scale, and calculates a scale for an actual length to a pixel by comparing a length of a unit line segment of the checkerboard with a number of pixels representing the unit line segment of the checkerboard in image data obtained by correcting image distortion.

4. The animal entity status information providing device of claim 1, wherein
the animal entity status information generation program identifies a corresponding animal entity when identifying that the animal entity enters the image-capturing region, identifies the animal entities based on characteristic information of the animal entity extracted from the image data or a color change of pixels in the image data, and counts an identified animal entity.

5. The animal entity status information providing device of claim 1, wherein
the animal entity status information generation program automatically performs an operation of counting the number of animal entities and estimating the weights of the animal entities from a time when the animal entities are identified in the image-capturing region to a time when the animal entities are not identified in the image-capturing region.

6. The animal entity status information providing device of claim 1, wherein
the animal entity status information generation program estimates the weights of the animal entities by inputting information on the calculated sizes of the animal entities to a lookup table representing a correlation between the sizes and weights of the animal entities.

7. The animal entity status information providing device of claim 6, wherein
the animal entity status information generation program stores characteristic information for each type of animal entities, compares the stored characteristic information for each type of animal entities with characteristic information on each individual entity identified from the image data, and determines a type of an animal of the identified animal entity,
the lookup tables includes multiple lookup tables depending on types of animal, and
the weights of the animal entities are estimated by inputting the information on the calculated sizes of the animal entities to the lookup table corresponding to the determined type of animal.

8. The animal entity status information providing device of claim 1, wherein
the animal entity status information generation program further outputs, as status information of the animal entities, an average of the estimated weights of the counted animal entities.

9. The animal entity status information providing device of claim 1, wherein
the animal entity status information generation program further outputs a suitable grade, an under grade, or an exceeding grade for each animal entity which are classified according to a difference between the reference weight and the estimated weight as animal entity status information and as a result of comparing the estimated weight with a preset reference weight or a reference weight set by a user.

10. An information providing server that provides animal entity status information collected from at least one animal entity status information providing device, the information providing server comprising:
a communication module;
a memory configured to store an animal entity status information providing program; and
a processor configured to execute the animal entity status information providing program,
wherein as the animal entity status information providing program is executed by the processor, the animal entity status information providing program collects animal entity status information from at least one animal entity status information providing device, and provides the animal entity status information through a user interface of a user terminal in response to a request of an external user terminal,
the animal entity status information includes a number of animal entities and an estimated weight of the animal entities collected by the animal entity status information providing device for a predetermined period of time,
the number of animal entities is collected through an operation of counting the animal entities by identifying, by the animal entity status information providing device, the animal entities in an image-capturing region of a camera, and
the estimated weight is collected through an operation of calculating, by the animal entity status information providing device, sizes of the animal entities by using a scale set through camera calibration, and estimating, by the animal entity status information providing device, weights of the animal entities based on the sizes of the animal entities.

11. The information providing server of claim 10, wherein
the animal entity status information providing program causes at least one camera, which is installed in a farm, to be selected through a first interface block executed by the user terminal, causes an image captured by a camera selected through the first interface block to be output through a second interface block, and causes information on an operation state of the camera selected through the first interface block to be output through a third interface block.

12. The information providing server of claim 10, wherein
the animal entity status information providing program displays a number of tasks including animal entity status information for each day through a calendar-based interface executed by the user terminal, and displays a report for each task in a form of a list through a report output interface block adjacent to the calendar-based interface,
the report for each task includes image data captured while a corresponding task is performed, and information on a number and an estimated weight of the animal entities counted during the corresponding task, and
the report for each task is generated in units of time previously determined by a user, or based on units of time from a time when the animal entities begin to be identified to a time when identification ends.

13. The information providing server of claim 12, wherein
the report output interface block is configured to output a highlight indicating a main grade for each report when the counted number of animal entities is greater than a threshold.

14. The information providing server of claim 10, wherein
the animal entity status information providing program displays information on the number of animal entities, an average weight, or a standard deviation for measurements performed during a certain period in a farm selected by a user through a statistical information providing interface executed by the user terminal, and displays the number and a distribution status of animal entities corresponding to an under grade, a suitable grade, and an exceeding grade by considering a normal distribution.

15. An animal entity status information generating method based on an image using an animal entity status information providing device, the animal entity status information generating method comprising:
calibrating a camera configured to set one region of a straight passage through which animal entities pass as an image-capturing region;
setting a scale for an actual length per pixel by using image data received from the camera;
counting the animal entities by identifying the animal entities in the image-capturing region from calibration-applied image data;
calculating a size of one of the animal entities in the image-capturing region by using the scale;
estimating weights of the animal entities based on the sizes of the animal entities; and
outputting animal entity status information including the counted number of animal entities and estimated weights of the animal entities.

16. The animal entity status information generating method of claim 15, wherein, in the setting of the scale,
image distortion is corrected based on an image obtained by capturing a checkerboard placed in the one region of the straight passage, and the scale is set, and
a scale for an actual length to a pixel is calculated by comparing a length of a unit line segment of the checkerboard with a number of pixels representing the unit line segment of the checkerboard in image data obtained by correcting image distortion.

17. The animal entity status information generating method of claim 15, wherein, in the counting of the animal entities by identifying the animal entities,
when identifying that the animal entity enters the image-capturing region, a corresponding animal entity is identified and the animal entities is identified based on characteristic information of the animal entity extracted from the image data or a color change of pixels in the image data, and an identified animal entity is counted.

18. The animal entity status information generating method of claim 15, wherein
an operation of counting the number of animal entities and estimating the weights of the animal entities is automatically performed from a time when the animal entities are identified in the image-capturing region to a time when the animal entities are not identified in the image-capturing region.

19. The animal entity status information generating method of claim 15, wherein, in the estimating of the weights of the animal entities,
the weights of the animal entities are estimated by inputting information on the calculated sizes of the animal entities to a lookup table representing a correlation between the sizes and weights of the animal entities.

20. The animal entity status information generating method of claim 19, wherein, in the estimating of the weights of the animal entities,
characteristic information for each type of animal entities is stored, the stored characteristic information for each type of animal entities is compared with characteristic information on each individual entity identified from the image data, and a type of an animal of the identified animal entity is determined, and
the lookup tables includes multiple lookup tables depending on types of animal, and
the weights of the animal entities are estimated by inputting the information on the calculated sizes of the animal entities to the lookup table corresponding to the determined type of animal.
